(19) United States
(12) Patent Application Publication
(10) Pub. No.: US 2025/0306223 A1
(43) Pub. Date: Oct. 2, 2025

(54) RADIOGRAPHIC IMAGING SYSTEM, RADIOGRAPHIC IMAGING APPARATUS, RADIOGRAPHIC IMAGING METHOD, AND STORAGE MEDIUM

(71) Applicant: KONICA MINOLTA, INC., Tokyo (JP)

(72) Inventor: Kazumichi IWATA, Tokorozawa-shi (JP)

(73) Assignee: KONICA MINOLTA, INC., Tokyo (JP)

(21) Appl. No.: 19/079,610

(22) Filed: Mar. 14, 2025

(30) Foreign Application Priority Data
Mar. 26, 2024 (JP) 2024-049118

(51) Int. Cl. G01T 7/00; G01T 1/175; G01T 1/29

(52) U.S. Cl. CPC G01T 7/005; G01T 1/175; G01T 1/2985

(57) ABSTRACT

A radiographic imaging system includes a radiation emission control apparatus and a radiographic imaging apparatus that is connected with the radiation emission control apparatus via a communicator. The radiation emission control apparatus includes a first time measurer that measures a time. The radiographic imaging apparatus includes a second time measurer that measures a time and a hardware processor that performs a time synchronization communication with the radiation emission control apparatus via the communicator to adjust the time of the second time measurer to the time of the first time measurer. The hardware processor corrects the time of the second time measurer in response to determining that a time difference between the first time measurer and the second time measurer in the time synchronization communication is equal to or smaller than a predetermined value.

### CROSS-REFERENCE TO RELATED APPLICATIONS

The entire disclosure of Japanese Patent Application No. 2024-049118, filed on Mar. 26, 2024, is incorporated herein by reference in its entirety.

### BACKGROUND OF THE INVENTION

### Technical Field

The present invention relates to a radiographic imaging system, a radiographic imaging apparatus, a radiographic imaging method, and a storage medium.

### Description of Related Art

In moving image shooting using radiation, radiation emission and radiographic imaging need to be alternately performed in tune. However, clocks such as crystal oscillators provided in an emission apparatus and an imaging apparatus each have a unique frequency error, which causes synchronization lag. Therefore, synchronization control for having the same timing reference is regularly performed between the emission apparatus and the imaging apparatus.

Japanese Unexamined Patent Publication No. 2022-100540 describes a radiographic imaging apparatus that, while an external interface is connected, generates, based on a timing signal from the external interface, a copy signal whose rising timing is equal to that of the timing signal. Japanese Unexamined Patent Publication No. 2020-103589 describes a time synchronization system including a time measurement controller that synchronizes time information obtained by transmission and reception of messages to and from a time server with time information of an internal clock.

### SUMMARY OF THE INVENTION

However, in Japanese Unexamined Patent Publication No. 2022-100540, since it does not determine whether the timing signal or the like from the external interface is abnormal, there is a problem that the synchronization lag occurs in a case where there is an abnormality value. In Japanese Unexamined Patent Publication No. 2020-103589, since the time synchronization is performed in consideration of the processing time in a device of a master unit, there is a problem that a synchronization error corresponding to the processing time in the device of the master unit occurs.

Therefore, in order to solve the above-described problems, an object of the present invention is to provide a radiographic imaging system, a radiographic imaging apparatus, a radiographic imaging method and a storage medium storing a program each capable of performing time synchronization with higher accuracy.

To achieve at least one of the abovementioned objects, according to an aspect of the present invention, a radiographic imaging system reflecting one aspect of the present invention includes:
a radiation emission control apparatus; and
a radiographic imaging apparatus that is connected with the radiation emission control apparatus via a communicator,
wherein the radiation emission control apparatus includes a first time measurer that measures a time,
wherein the radiographic imaging apparatus includes:
   a second time measurer that measures a time; and
   a hardware processor that performs a time synchronization communication with the radiation emission control apparatus via the communicator to adjust the time of the second time measurer to the time of the first time measurer, and
wherein the hardware processor corrects the time of the second time measurer in response to determining that a time difference between the first time measurer and the second time measurer in the time synchronization communication is equal to or smaller than a predetermined value.

According to an aspect of the present invention, a radiographic imaging apparatus reflecting one aspect of the present invention is to be connected with a radiation emission control apparatus via a communicator and includes:
a time measurer that measures a time; and
a hardware processor that performs a time synchronization communication with the radiation emission control apparatus via the communicator to adjust the time of the time measurer to a time measured by the radiation emission control apparatus, and
wherein the hardware processor corrects the time of the time measurer in response to determining that a time difference between the radiation emission control apparatus and the radiographic imaging apparatus in the time synchronization communication is equal to or smaller than a predetermined value.

According to an aspect of the present invention, a radiographic imaging method reflecting one aspect of the present invention is performed by a radiographic imaging apparatus to be connected with a radiation emission control apparatus via a communicator and includes:
performing a time synchronization communication with the radiation emission control apparatus via the communicator to adjust a time of the radiographic imaging apparatus to a time measured by the radiation emission control apparatus,
wherein the performing includes correcting the time of the radiographic imaging apparatus in response to determining that a time difference between the radiation emission control apparatus and the radiographic imaging apparatus in the time synchronization communication is equal to or smaller than a predetermined value.

According to an aspect of the present invention, a non-transitory computer-readable storage medium reflecting one aspect of the present invention stores a program causing a radiographic imaging apparatus as a computer to be connected with a radiation emission control apparatus via a communicator to:
measure a time; and
perform a time synchronization communication with the radiation emission control apparatus via the communicator to adjust the measured time to a time measured by the radiation emission control apparatus,
wherein the program causes the computer to correct the measured time in response to determining that a time difference between the radiation emission control apparatus and the radiographic imaging apparatus in the time synchronization communication is equal to or smaller than a predetermined value.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating an example of a schematic configuration of a radiographic imaging system according to the present embodiment;

FIG. 2 is a flowchart illustrating an example of operation of an imaging apparatus when it performs time synchronization communication with a control apparatus according to the present embodiment;

FIG. 3 is a conceptual diagram of the time synchronization communication and the like performed between the control apparatus and the imaging apparatus according to the present embodiment;

FIG. 4 is a diagram for explaining the time synchronization communication using IEEE 1588 PTP according to the present embodiment;

FIG. 5A is a diagram illustrating an example of execution state information displayed on an examination screen of a display part of a user operation terminal according to the present embodiment;

FIG. 5B is a diagram illustrating another example of the execution state information displayed on the examination screen of the display part of the user operation terminal according to the present embodiment;

FIG. 5C is a diagram illustrating another example of the execution state information displayed on the examination screen of the display part of the user operation terminal according to the present embodiment; and

FIG. 5D is a diagram illustrating another example of the execution state information displayed on the examination screen of the display part of the user operation terminal according to the present embodiment.

### DETAILED DESCRIPTION

Hereinafter, one or more embodiments of the present invention will be described with reference to the drawings. However, the scope of the invention is not limited to the disclosed embodiments.

Hereinafter, one or more preferred embodiments of a radiographic imaging system, a radiographic imaging apparatus, a radiographic imaging method and a storage medium storing a program according to the present disclosure will be described in detail with reference to the accompanying drawings.

### [Configuration Example of Radiographic Imaging System 1]

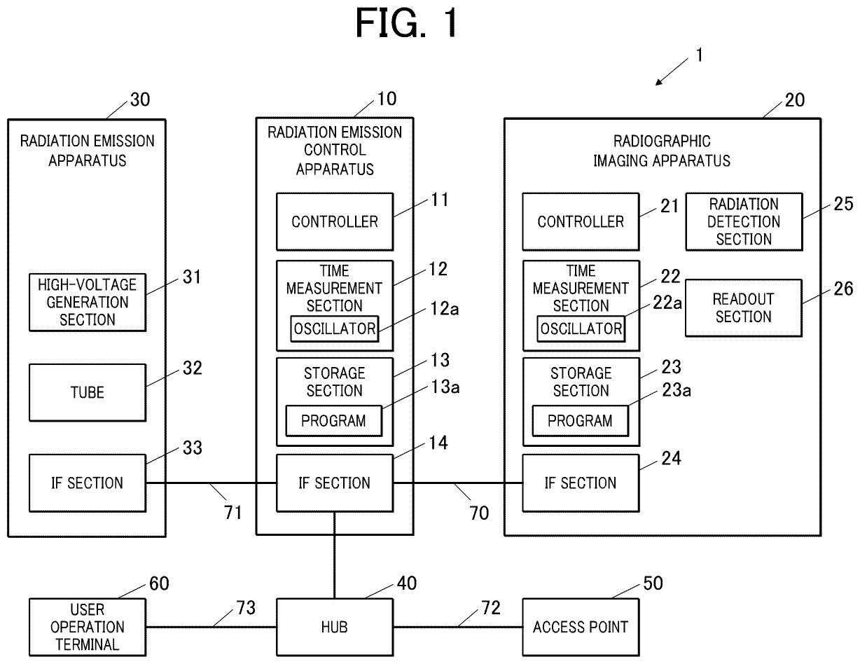

FIG. 1 is a diagram illustrating an example of a schematic configuration of a radiographic imaging system 1 according to the present embodiment. As illustrated in FIG. 1, the radiographic imaging system 1 includes a radiation emission control apparatus 10, a radiographic imaging apparatus 20, a radiation emission apparatus 30, a hub 40, an access point 50, and a user operation terminal 60. Hereinafter, the radiation emission control apparatus 10 is referred to as a control apparatus 10, the radiographic imaging apparatus 20 is referred to as an imaging apparatus 20 or an imaging panel, and the radiation emission apparatus 30 is referred to as an emission apparatus 30. The control apparatus 10 and the imaging apparatus 20 are communicably connected with one another via a communication cable 70. For example, a LAN cable conforming to the PoE standard is used as the communication cable 70. PoE is an abbreviation for Power over Ethernet. LAN is an abbreviation for Local Area Network. Other than the connection method using the communication cable 70, the control apparatus 10 and the imaging apparatus 20 may be connected with one another via, for example, the hub 40, or may be wirelessly connected with one another via the access point 50. The control apparatus 10 and the emission apparatus 30 are communicably connected with one another via a dedicated communication cable 71.

The control apparatus 10 obtains an imaging condition set by the user operation terminal 60 or the like described later, and transmits the obtained imaging condition to the emission apparatus 30. Examples of the imaging condition include an imaging mode related to still image shooting or dynamic imaging, conditions related to an imaging target site and the like, conditions related to radiation emission such as a tube voltage, a tube current, an additional filter, an emission time and a frame rate. The control apparatus 10 generates, based on the time in the apparatus, a timing pulse signal serving as a reference at the time of radiation emission by the emission apparatus 30, and transmits the generated timing pulse signal to the emission apparatus 30.

The imaging apparatus 20 detects radiation emitted from the emission apparatus 30 to generate digital image data in which an imaging part of a subject S is captured. For example, a portable FPD can be used as the imaging apparatus 20. FPD is an abbreviation for Flat Panel Detector. In the present embodiment, the imaging apparatus 20 performs time synchronization communication with the control apparatus 10 via the communication cable 70 in order to adjust the time in the apparatus to the time of the control apparatus 10. The imaging apparatus 20 generates a timing pulse signal serving as a reference at the time of imaging, using the time based on the time synchronization communication.

The emission apparatus 30 generates radiation such as X-rays, for example, on the basis of the imaging condition, the timing pulse signal, and the like obtained from the control apparatus 10, and irradiates the subject with the generated radiation. The emission apparatus 30 generates radiation in a mode corresponding to the type of radiographic image, for example, a still image or a dynamic image. Specifically, in the case of a still image, the emission apparatus 30 emits radiation only once per press of an emission instruction switch. In the case of a dynamic image, the emission apparatus 30 repeatedly irradiates the subject with pulsed radiation at predetermined time intervals in accordance with one imaging operation for dynamic imaging to obtain a series of images of the subject. Repeatedly emitting pulsed radiation at predetermined time intervals is referred to as pulsed emission. The dynamic imaging includes a case in which a series of images of the subject is obtained by continuously irradiating the subject with a low dose rate in accordance with one imaging operation. Continuously emitting radiation without interruption is referred to as continuous emission. A series of images obtained by dynamic imaging is called a dynamic image. Furthermore, each of all images forming a dynamic image is referred to as a frame image. The dynamic imaging includes moving image shooting, but does not include shooting a still image while displaying a moving image. Furthermore, the dynamic image includes a moving image, but does not include an image obtained by capturing a still image while displaying a moving image.

The hub 40 is, for example, a switching hub and has a plurality of ports. The access point 50 is connected with the hub 40 via a communication cable 72 and includes a device for transmitting and receiving radio waves of a wireless LAN such as Wi-Fi®. For example, when the imaging apparatus 20 is used wirelessly, the access point 50 is used.

The user operation terminal 60 is, for example, a console and is connected with the hub 40 via the communication cable 73. Based on an imaging order obtained from an HIS, an RIS, or the like, the user operation terminal 60 sets the imaging condition, such as an imaging mode such as dynamic imaging, a tube voltage, an imaging part, an imaging direction, and a frame rate. HIS is an abbreviation for Hospital Information Systems. RIS is an abbreviation for Radiology Information System. The imaging condition may be set by, for example, a user such as a radiologist operating an operation part (not illustrated). The user operation terminal 60 obtains the image data of the radiographic image generated by the imaging apparatus 20, and performs image editing, saving, and the like of the obtained image data.

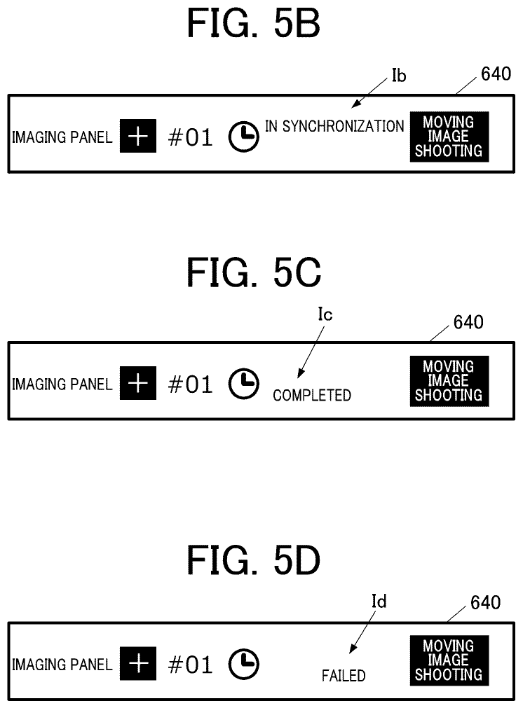

Matters other than the imaging condition may be settable on the user operation terminal 60. For example, in a case where there are two or more imaging apparatuses 20 in the same imaging room, whether to perform the time synchronization communication may be set for each of the imaging apparatuses 20. Specifically, the user operation terminal 60 may display a setting screen on which whether to perform the time synchronization communication can be selected for each of the imaging apparatuses 20 and receive, on the setting screen, an instruction on whether to perform the time synchronization communication by a user operation. The setting screen may be an examination screen (in FIG. 5A) described later or may be a screen different from it.

### [Configuration Example of Control Apparatus 10]

Next, the control apparatus 10 will be described in detail. The control apparatus 10 includes a controller 11 (hardware processor), a time measurement section 12, a storage section 13, and an interface section 14. Hereinafter, the interface section 14 is referred to as an IF section 14 for convenience. The controller 11, the time measurement section 12, the storage section 13, and the IF section 14 are connected by wiring such as a bus (not illustrated). A predetermined amount of electric power is supplied to each component such as the controller 11 by a power cable or built-in power source (not illustrated).

The controller 11 includes, for example, a processor such as a CPU that performs calculation and control, a memory, and the like. CPU is an abbreviation for Central Processing Unit. The controller 11 may include an electronic circuit such as an ASIC or an FPGA. ASIC is an abbreviation for Application Specific Integrated Circuit. FPGA is an abbreviation for Field Programmable Gate Array. The controller 11 executes programs stored in a memory such as a RAM, the storage section 13, or the like to realize various processes including control related to emission, the time synchronization communication with the imaging apparatus 20, and the like. RAM is an abbreviation for Random Access Memory.

The time measurement section 12 includes an emission-side oscillator 12a. Note that the time measurement section 12 is an example of a first time measurer, and the emission-side oscillator 12a is an example of a first oscillator. The emission-side oscillator 12a is constituted by, for example, a crystal oscillator, a ceramic oscillator, or the like, and generates a timing pulse signal of a predetermined cycle. The emission-side oscillator 12a has an oscillation error of 100 ppm or less and can generate a timing pulse signal with high accuracy. When performing the time synchronization communication with the imaging apparatus 20, the time measurement section 12 obtains a time stamp indicating the time of a round-trip of a communication message.

The storage section 13 includes a storage module such as an HDD, an SSD, a ROM, or a RAM. HDD is an abbreviation for Hard Disk Drive. SSD is an abbreviation for Solid State Drive. ROM is an abbreviation for Read Only Memory. The storage section 13 stores, for example, a system program, application programs, and various kinds of data. To be specific, the storage section 13 stores a program 13a for performing control related to emission of the emission apparatus 30 and performing a process of performing the time synchronization communication with the imaging apparatus 20.

The IF section 14 can be connected with the imaging apparatus 20 via the communication cable 70, and transmits and receives various kinds of information such as the imaging condition to and from the imaging apparatus 20. The IF section 14 can be connected with the emission apparatus 30 via the communication cable 71, and transmits and receives various kinds of information such as the imaging condition to and from the emission apparatus 30. The IF section 14 includes, for example, connectors or the like for enabling attachment and detachment of the communication cables 70 and 71.

### [Configuration Example of Imaging Apparatus 20]

Next, the imaging apparatus 20 will be described in detail. As illustrated in FIG. 1, the imaging apparatus 20 includes a controller 21 (hardware processor), a time measurement section 22, a storage section 23, an interface section 24, a radiation detection section 25, and a readout section 26. Hereinafter, the interface section 24 is referred to as an IF section 24 for convenience. The controller 21, the time measurement section 22, the storage section 23, the IF section 24, the radiation detection section 25, and the readout section 26 are connected by wiring (not illustrated). In the present embodiment, a communication cable 70 conforming to the PoE standard is used as the communication cable 70. Therefore, a predetermined amount of electric power is supplied to each component such as the controller 21 of the imaging apparatus 20 from the control apparatus 10 via the communication cable 70.

The controller 21 includes, for example, a processor such as a CPU that performs calculation and control, a memory, and the like. The controller 21 may include an electronic circuit such as an ASIC or an FPGA. The controller 21 executes a program(s) 23a stored in a memory such as a RAM, the storage section 23, or the like to realize various processes including control related to imaging, a time synchronization step related to the time synchronization communication, and the like. To be specific, the controller 21 functions as a time synchronization section, and executes the program 23a to perform the time synchronization communication with the control apparatus 10 via the communication cable 70 for adjusting the time of the imaging apparatus 20 to the time of the control apparatus 10. In the time synchronization communication, when determining that the time difference between the time measurement section 12 of the control apparatus 10 and the time measurement section 22 of the imaging apparatus 20 of a communication message (packet) is equal to or less than a preset threshold value, the controller 21 corrects its own time based on the time difference.

The time measurement section 22 includes an imaging-side oscillator 22a. Note that the time measurement section 22 is an example of a second time measurer, and the imaging-side oscillator 22a is an example of a second oscillator. The imaging-side oscillator 22a is constituted by, for example, a crystal oscillator, a ceramic oscillator, or the like, and generates a timing pulse signal of a predetermined cycle. The imaging-side oscillator 22a has an oscillation error of 100 ppm or less and can generate a timing pulse signal with high precision. When performing the time synchronization communication with the imaging apparatus 20, the time measurement section 22 obtains a time stamp indicating the time of a round-trip of a communication message.

The storage section 23 includes a storage module such as an HDD, an SSD, a ROM, or a RAM. The storage section 23 stores, for example, a system program, application programs, and various kinds of data. To be specific, the storage section 23 stores the program 23a for performing control related to emission of the emission apparatus 30 and performing a process of performing the time synchronization communication with the control apparatus 10.

The IF section 24 can be connected with the control apparatus 10 via the communication cable 70, and transmits and receives various kinds of information such as the imaging condition to and from the control apparatus 10. The IF section 24 includes, for example, a connector or the like for enabling attachment and detachment of the communication cable 70.

The radiation detection section 25 includes at least radiation detection elements and a substrate. The radiation detection elements directly or indirectly generate charges corresponding to the dose of radiation received from the outside. On the substrate, pixels are two dimensionally arranged, each of the pixels being provided between a radiation detection element and wiring and including a switch element that can switch the radiation detection element and the wiring to be conductive or nonconductive. The readout section 26 reads out signal values corresponding to the amounts of charges accumulated in the radiation detection elements, and generates image data of a radiographic image based on the readout signal values.

### [Configuration Example of Emission Apparatus 30]

Next, the emission apparatus 30 will be described in detail. As illustrated in FIG. 1, the emission apparatus 30 includes a high-voltage generation section 31, a tube 32, and an interface section 33. Hereinafter, the interface section 33 is referred to as the IF section 33 for convenience. The high-voltage generation section 31 applies, to the tube 32, a voltage corresponding to the set imaging condition on the basis of the timing pulse signal transmitted from the control apparatus 10. When a predetermined voltage is applied to the tube 32 by the high-voltage generation section 31, the tube 32 generates a dose of radiation corresponding to the applied voltage.

The IF section 33 can be connected with, for example, the IF section 14 of the control apparatus 10, and transmits and receives various kinds of information such as the imaging condition to and from the control apparatus 10. The IF section 33 includes, for example, a connector for enabling attachment and detachment of the communication cable 71.

### [Operation Example of Imaging Apparatus 20]

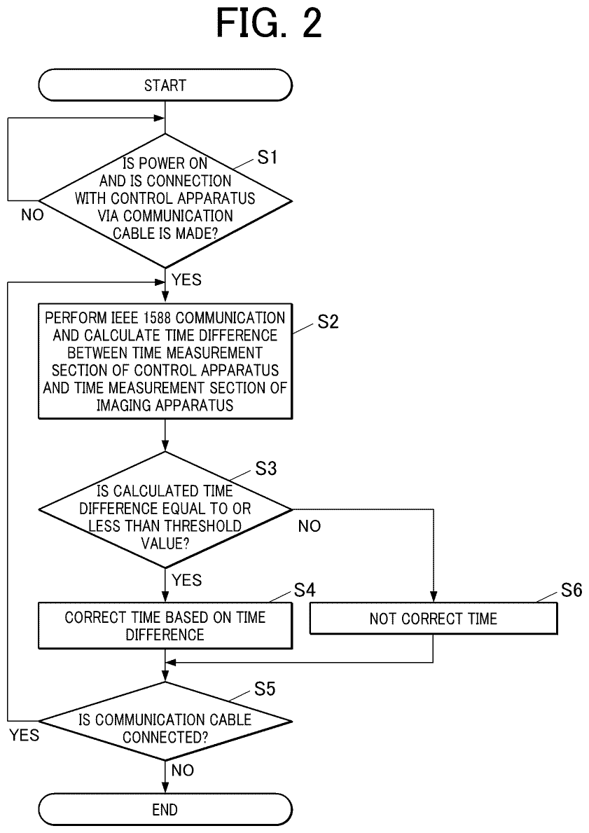

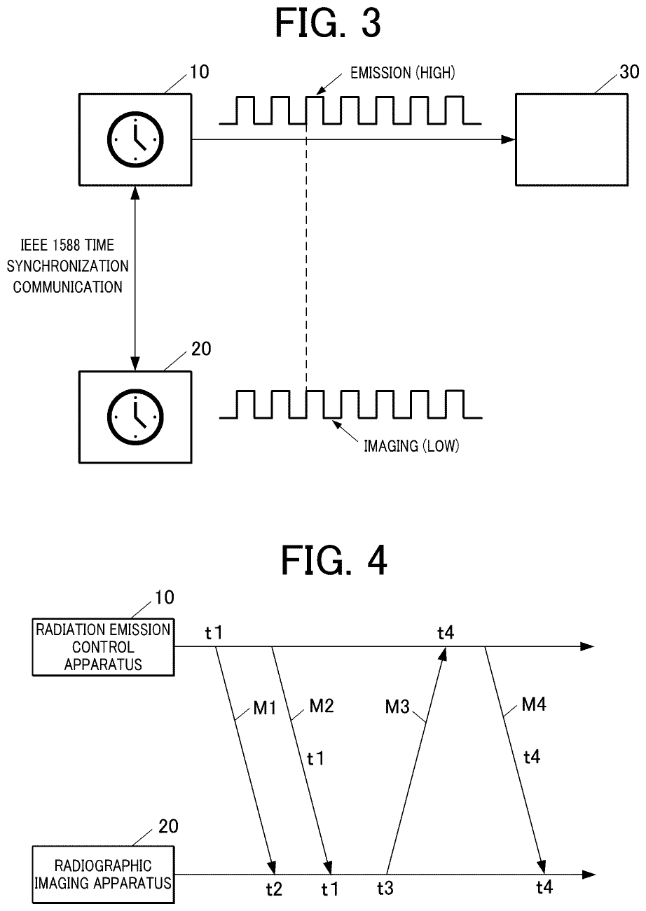

FIG. 2 is a flowchart illustrating an example of the operation of the imaging apparatus 20 when the time synchronization communication is performed with the control apparatus 10 according to the present embodiment. FIG. 3 is a conceptual diagram for explaining the time synchronization communication and the like performed between the control apparatus 10 and the imaging apparatus 20 according to the present embodiment. Hereinafter, a processor such as the controller 21 executes the program stored in the storage section 23 to realize the following steps.

As illustrated in FIG. 2, the controller 21 of the imaging apparatus 20 determines whether the power is on and it is connected with the control apparatus 10 via the communication cable 70 (Step S1). If the controller 21 determines that the power is on and it is connected with the control apparatus 10 via the communication cable 70, the controller 21 proceeds to Step S2. On the other hand, if the controller 21 determines that the power is on but it is not connected with the control apparatus 10 via the communication cable 70, the controller 21 continuously checks whether these conditions are satisfied.

As illustrated in FIG. 3, the controller 21 performs the time synchronization communication with the control apparatus 10, and calculates a time difference between the time measurement section 12 of the control apparatus 10 and the time measurement section 22 of the imaging apparatus 20 (Step S2). For the time synchronization communication, a communication method using a time synchronization method by LAN communication called IEEE 1588 PTP can be used. PTP is an abbreviation for Precision Time Protocol. The time synchronization communication may be performed by a communication method using a time synchronization method different from IEEE 1588 PTP. In a case where a radiographic image is being captured, in particular, in a case of dynamic imaging, the controller 21 may perform control not to perform the time synchronization communication, from the viewpoint of reducing the communication load and reducing power consumption.

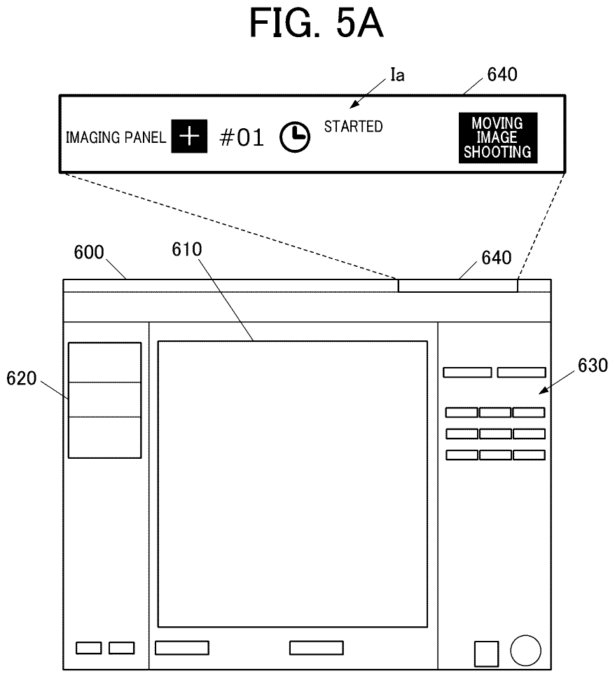

FIG. 4 is a diagram for explaining the time synchronization communication using IEEE 1588 PTP according to the present embodiment. The time synchronization communication can be performed by the following procedure of (1) to (8).
(1) The IF section 14 of the control apparatus 10 transmits a communication message M1 to the imaging apparatus 20. The controller 11 may transmit the communication message M1, for example, when receiving an instruction requesting the start of the time synchronization communication from the imaging apparatus 20.
(2) The IF section 24 of the imaging apparatus 20 receives the communication message M1 transmitted from the control apparatus 10. The time measurement section 22 obtains time t2 at which the communication message M1 passed through the IF section 24.
(3) The time measurement section 12 of the control apparatus 10 obtains time t1 at which the communication message M1 was transmitted from the IF section 14. The IF section 14 adds the time t1 to a communication message M2 and transmits the communication message M2 to the imaging apparatus 20.
(4) The IF section 24 of the imaging apparatus 20 receives the communication message M2 transmitted from the control apparatus 10.
(5) The IF section 24 of the imaging apparatus 20 transmits a communication message M3 to the control apparatus 10. The time measurement section 22 obtains time M3 at which the communication message t3 was transmitted from the IF section 24.
(6) The IF section 14 of the control apparatus 10 receives the communication message M3 transmitted from the imaging apparatus 20. The time measurement section 12 obtains time t4 at which the communication message M3 was received from the IF section 14.
(7) The IF section 14 of the control apparatus 10 adds the obtained time t4 to a communication message M4 and transmits the communication message M4 to the imaging apparatus 20.
(8) The IF section 24 of the imaging apparatus 20 receives the communication message M4 transmitted from the control apparatus 10.

The controller 21 calculates a time difference between the time of the control apparatus 10 and the time of the imaging apparatus 20 using the times t1 to t4 obtained by the time synchronization communication illustrated in FIG. 4. The time difference can be obtained by the following formula (1).

$$( ( t 2 - t 1 ) - ( t 4 - t 3 ) ) / 2 \qquad ( 1 )$$

Note that in the above formula (1), the times t1 and t3 correspond to transmission time, and the times t2 and t4 correspond to reception time.

The controller 21 may notify the user of the execution state of the time synchronization communication. Specifically, when starting the time synchronization communication, the controller 21 outputs, to the user operation terminal 60, execution state information I indicating that the time synchronization communication has been started. Upon receiving the execution state information I from the imaging apparatus 20, the user operation terminal 60 displays the execution state information I in a part of the below-described examination screen, which will be described later, of its display part.

FIG. 5A is a diagram illustrating an example of the execution state information I displayed on an examination screen 600 of the display part of the user operation terminal 60 according to the present embodiment. The examination screen 600 is provided with an image display section 610, an imaging information display section 620, a setting section 630, a panel information display section 640, and the like. The image display section 610 is a region where a radiographic image captured by the imaging apparatus 20 is displayed. The imaging information display section 620 is a region where various kinds of information related to an examination order are displayed. In the setting section 630, for example, buttons for editing a radiographic image and for setting the imaging condition are displayed. The panel information display section 640 is a region where various kinds of information related to the imaging apparatus 20 are displayed. The panel information display section 640 is arranged at the top of the examination screen 600, but its' position is not limited to the position illustrated in FIG. 5A. When receiving, from the imaging apparatus 20, the execution state information I indicating that the time synchronization communication has been started, the user operation terminal 60 displays text information Ia of “Started” in the panel information display section 640 of the examination screen 600.

In a case where the time difference from the time of the control apparatus 10 is being calculated after the start of the time synchronization communication, the controller 21 may output the execution state information I indicating that the synchronization by the time synchronization communication is being performed to the user operation terminal 60. FIG. 5B is a diagram illustrating an example of the execution state information I displayed on the examination screen 600 of the display part of the user operation terminal 60 according to the present embodiment. When receiving the execution state information I from the imaging apparatus 20, the user operation terminal 60 displays text information Ib of “In Synchronization” in the panel information display section 640 of the examination screen 600 of the display part.

The controller 21 determines whether the calculated time difference is equal to or smaller than a preset threshold value (Step S3). The threshold value can be set, for example, for the purpose of determining a certain time difference due to crystal frequency deviation of at least one of the emission-side oscillator 12a of the control apparatus 10 and the imaging-side oscillator 22a of the imaging apparatus 20 and a round-trip communication time difference other than the crystal frequency deviation. If the controller determines that the type of radiographic imaging is dynamic imaging, the controller 21 may change the threshold value according to the number of images that are captured per second in the dynamic imaging, that is, the frame rate. Specifically, in the case where the frame rate of the dynamic imaging is low, it is not necessary to strictly manage the timings of the emission and the imaging as compared with the case where the frame rate is high. Therefore, the threshold value may be set larger when the frame rate of the dynamic imaging is low than when the frame rate is high. If the controller 21 determines that the calculated time difference is equal to or less than the preset threshold value, the controller 21 proceeds to Step S4.

The controller 21 corrects its own time based on the calculated time difference and adjusts the time of the imaging apparatus 20 to the time of the control apparatus 10 (Step S4). If there is no time difference between the time of the imaging apparatus 20 and the time of the control apparatus 10, the controller 21 does not correct its own time. In this case, the controller 21 determines that the time synchronization with the control apparatus 10 has succeeded, and permits execution of radiographic imaging. As illustrated in FIG. 3, the controller 21 generates a timing pulse signal after a certain time elapses from the corrected time or when a set time arrives. The imaging apparatus 20 performs imaging in a Low period of the timing pulse signal. The controller 11 of the control apparatus 10 generates a timing pulse signal based on its own time, and transmits the generated timing pulse signal to the emission apparatus 30. The emission apparatus 30 performs radiation emission in a High period of the timing pulse signal. Thus, the timing pulse signal generated by the controller 21 can be synchronized with the timing pulse signal generated by the control apparatus 10. That is, the phase of the timing pulse signal on the imaging apparatus 20 side and the phase of the timing pulse signal on the emission apparatus 30 side can be made to coincide with one another. Note that if the imaging mode is dynamic imaging, the controller 21 may change the cycle of the timing pulse signal according to the frame rate.

When the controller 21 corrects its own time by the time synchronization communication, the controller 21 outputs, to the user operation terminal 60, the execution state information I indicating that the synchronization by the time synchronization communication has been completed. FIG. 5C is a diagram illustrating an example of the execution state information I displayed on the examination screen 600 of the display part of the user operation terminal 60 according to the present embodiment. When receiving the execution state information I from the imaging apparatus 20, the user operation terminal 60 displays text information Ic of “Completed” in the panel information display section 640 of the examination screen 600 of the display part. In this case, the user may be notified that the time synchronization has been completed by outputting sound or by causing an illumination device, such as an LED, to emit light.

The controller 21 determines whether it is connected with the control apparatus 10 via the communication cable 70 (Step S5). If the controller 21 determines that it is connected with the control apparatus 10 via the communication cable 70, the controller 21 returns to Step S2 and repeatedly performs the above-described time synchronization communication. In this case, since the time synchronization with the control apparatus 10 is successful, the controller 21 may perform the next time synchronization communication, for example, after a certain period elapses, in order to reduce the communication load or the like. On the other hand, if the controller 21 determines that it is not connected with the control apparatus 10 via the communication cable 70, that is, the communication cable 70 is removed from the IF section 24, the controller 21 ends the time synchronization communication.

Note that when the connection with the control apparatus 10 via the communication cable 70 is released, the imaging apparatus 20 can correct its own time by using the time difference obtained by the time synchronization communication as a correction value. In the present embodiment, both the emission-side oscillator 12a and the imaging-side oscillator 22a has an oscillation error of 100 ppm or less, and thus the timing pulse signals can be generated with higher accuracy. Therefore, even in a case where, for example, a time of about 30 minutes elapses after the imaging apparatus 20 is disconnected from the control apparatus 10, it is possible to maintain a state in which the time synchronization with the control apparatus 10 is achieved.

At the time, in the imaging apparatus 20, a time for which the time synchronization can be ensured in a wireless state, for example, 30 minutes, may be set in advance as the synchronization maintenance time. If the wireless state exceeds the synchronization maintenance time set in advance, the imaging apparatus 20 determines that there is a high possibility that the time synchronization with the control apparatus 10 cannot be achieved, and performs control so as not to permit radiographic imaging. In addition, in the case where the synchronization maintenance time has been exceeded, notification of warning information indicating that the time maintenance time has been exceeded may be performed in the imaging apparatus 20, the user operation terminal 60, or the like. In addition, in the case where the synchronization maintenance time has been exceeded, the imaging apparatus 20 may be connected with the control apparatus 10 again via the communication cable 70, and notification of warning information indicating that the time synchronization communication will be performed again may be performed in the imaging apparatus 20, the user operation terminal 60, or the like.

If the controller 21 determines in Step S3 that the calculated time difference is not equal to or less than the preset threshold value, that is, the calculated time difference exceeds the threshold value, the controller 21 proceeds to Step S6. In this case, the controller 21 determines that the time synchronization with the control apparatus 10 has failed, and proceeds to Step S5 without correcting the time. Examples of the case include a case where, to the control apparatus 10 or the imaging apparatus 20 performing the time synchronization communication, LAN communication is simultaneously performed from the user operation terminal 60, another imaging apparatus 20, and/or the like. In this case, communications are simultaneously transmitted to the hub 40, so that waiting of packets occurs in the hub 40. At the time, if the packet for which the time synchronization communication is being performed is the last packet, a transmission delay occurs in the time synchronization communication, and the calculated round-trip communication time difference of the packet may exceed the threshold value. When the communication cable 70 is in connected with the IF section 24, the controller 21 performs the time synchronization communication again. When the time synchronization communication is performed again, the number of retries may be set in advance. Note that the controller 21 may temporarily stop the time synchronization communication. In these cases, in order to ensure the reliability of radiographic imaging, the controller 21 performs control so as not to permit execution of radiographic imaging until the time synchronization with the control apparatus 10 succeeds.

When the controller 21 does not correct its own time by the time synchronization communication, the controller 21 outputs, to the user operation terminal 60, the execution state information I indicating that the synchronization by the time synchronization communication has failed. FIG. 5D is a diagram illustrating an example of the execution state information I displayed on the examination screen 600 of the display part of the user operation terminal 60 according to the present embodiment. When receiving the execution state information I from the imaging apparatus 20, the user operation terminal 60 displays text information Id of “Failed” in the panel information display section 640 of the examination screen 600 of the display part. If the time synchronization with the control apparatus 10 has failed and dynamic imaging is set, the controller 21 may display warning information indicating that dynamic imaging cannot be performed, on the display part of the user operation terminal 60.

Note that the imaging apparatus 20 may determine whether execution of radiographic imaging is possible based on whether the control apparatus 10 has an ID common to its own ID in addition to the conditions illustrated in FIG. 2. More specifically, the imaging apparatus 20 assigns an ID common to the ID owned by the imaging apparatus 20 to the control apparatus 10 that is connected with the imaging apparatus 20 via the communication cable 70 and with which the imaging apparatus 20 is time-synchronized. Note that the control apparatus 10 may assign an ID common to the ID owned by the control apparatus 10 to the imaging apparatus 20 with which the time synchronization is achieved. The imaging apparatus 20 compares the ID owned by itself with the ID owned by the control apparatus 10. If the IDs match, the imaging apparatus 20 determines that the time synchronization with the control apparatus 10 is achieved, and permits imaging of a radiographic image. On the other hand, if the IDs do not match, the imaging apparatus 20 determines that the time synchronization with the control apparatus 10 is not achieved, changes to a synchronization failure or out-of-synchronization state, and does not permit imaging. Examples of the case where the IDs do not match include a case where the control apparatus 10 with which the time synchronization is achieved is changed to another control apparatus and a case where the setting of the control apparatus 10 with which the time synchronization is achieved is changed or the control apparatus 10 has been restarted.

The imaging apparatus 20 may determine whether to perform the time synchronization communication on the basis of whether the type of radiographic imaging is dynamic imaging in addition to the conditions illustrated in FIG. 2. Specifically, the controller 21 of the imaging apparatus 20 obtains information on the imaging mode from the control apparatus 10, and performs the time synchronization communication with the control apparatus 10 when determining that the imaging mode is dynamic imaging. On the other hand, when the controller 21 determines that the type of radiographic imaging is still image shooting, the controller 21 does not perform the time synchronization communication with the control apparatus 10. This is because it is not necessary to synchronize the emission timing and the imaging timing with one another with high accuracy in still image shooting, unlike in dynamic imaging.

As described above, in the present embodiment, the imaging apparatus 20 performs the time synchronization communication with the control apparatus 10, and if the time difference calculated in the time synchronization communication is equal to or smaller than the threshold value, corrects its own time based on the calculated time difference. Thus, the timing pulse signal generated on the imaging apparatus 20 side can be synchronized with the timing pulse signal generated on the control apparatus 10 side. On the other hand, if the time difference calculated in the time synchronization communication exceeds the threshold value, the imaging apparatus 20 determines that the time synchronization with the control apparatus 10 has failed, and can perform the time synchronization communication again or stop the time synchronization communication. As described above, according to the present embodiment, it is possible to ensure the accuracy of the time synchronization and improve the reliability by making an abnormal value determination when correcting the clock deviation of the imaging apparatus 20 by the time synchronization communication. In addition, even in a case where accuracy of time is reduced due to an individual difference and/or a temperature characteristic difference between the emission-side oscillator 12a and the imaging-side oscillator 22a, it is possible to suppress a decrease in accuracy of the time synchronization. Furthermore, in the present embodiment, if the time synchronization fails, control is performed, for example, such that radiographic imaging such as dynamic imaging cannot be performed, which can ensure the reliability of radiographic imaging.

According to the present embodiment, the execution state of the time synchronization communication is output to the display part or the like of the user operation terminal 60, so that the user can check the execution state, such as whether the time synchronization between the control apparatus 10 and the imaging apparatus 20 has been completed. Thus, the user himself/herself can determine whether radiographic imaging can be performed, whether selection of an imaging mode or the like is appropriate, and the like.

According to the present embodiment, since the time synchronization communication with the control apparatus 10 is performed by using IEEE 1588 PTP, it is possible to prevent the round-trip time of a communication message from being influenced by the internal processing time of the control apparatus 10. Thus, the time synchronization can be performed with higher accuracy.

According to the present embodiment, when it is determined that the imaging mode of radiographic imaging is dynamic imaging, the threshold value is changed according to the frame rate. Thus, in the case where the frame rate of dynamic imaging is low, the threshold value can be set to be large so as to correspond to the low frame rate, and thus it is possible to reduce the time synchronization communication performed again due to the time synchronization failure with the control apparatus 10. Therefore, the communication load and the power consumption can be reduced.

Although one or more preferred embodiments of the present disclosure have been described in detail with reference to the accompanying drawings, the technical scope of the present disclosure is not limited to such examples. It is to be understood that various modification examples and improvements made by persons having ordinary knowledge in the technical field of the present disclosure within the scope of the technical idea described in claims naturally belong to the technical scope of the present disclosure.

For example, in dynamic imaging, a plurality of imaging apparatuses 20 may be used to capture a long dynamic image. Furthermore, the imaging apparatus 20 may be mounted on, for example, a medical cart. If, as the communication cable 70, not a LAN cable but a pulse-dedicated line is connected with the IF section 24, the imaging apparatus 20 may preferentially generate a timing pulse signal for imaging without performing the time synchronization communication.

Although embodiments of the present invention have been described and illustrated in detail, the disclosed embodiments are made for purposes of illustration and example only and not limitation. The scope of the present invention should be interpreted by terms of the appended claims.

What is claimed is:

1. A radiographic imaging system comprising:
a radiation emission control apparatus; and
a radiographic imaging apparatus that is connected with the radiation emission control apparatus via a communicator,
wherein the radiation emission control apparatus includes a first time measurer that measures a time,
wherein the radiographic imaging apparatus includes:
a second time measurer that measures a time; and
a hardware processor that performs a time synchronization communication with the radiation emission control apparatus via the communicator to adjust the time of the second time measurer to the time of the first time measurer, and
wherein the hardware processor corrects the time of the second time measurer in response to determining that a time difference between the first time measurer and the second time measurer in the time synchronization communication is equal to or smaller than a predetermined value.

2. The radiographic imaging system according to claim 1, wherein the hardware processor outputs, to a display, an execution state including at least (i) start of the time synchronization communication, (ii) during synchronization of the time synchronization communication, (ii) synchronization completion of the time synchronization communication, or (iv) synchronization failure of the time synchronization communication.

3. The radiographic imaging system according to claim 1, wherein identification information is assigned to the radiation emission control apparatus and the radiographic imaging apparatus that are time-synchronized with one another.

4. The radiographic imaging system according to claim 1, wherein in a case where radiographic imaging apparatuses each of which is the radiographic imaging apparatus are present, whether to perform the time synchronization communication is selectable for each of the radiographic imaging apparatuses.

5. The radiographic imaging system according to claim 1, wherein in response to a type of radiographic imaging being dynamic imaging, the hardware processor of the radiographic imaging apparatus performs the time synchronization communication.

6. The radiographic imaging system according to claim 1,
wherein the first time measurer of the radiation emission control apparatus includes a first oscillator,
wherein the second time measurer of the radiographic imaging apparatus includes a second oscillator, and
wherein the first oscillator and the second oscillator have an oscillation error of 100 ppm or less.

7. The radiographic imaging system according to claim 1, wherein in response to the radiographic imaging apparatus connected with the radiation emission control apparatus via the communicator being disconnected therefrom, the hardware processor of the radiographic imaging apparatus corrects the time measured by the second time measurer using a time correction value based on the time difference.

8. The radiographic imaging system according to claim 1, wherein in response to a type of radiographic imaging being dynamic imaging, the hardware processor of the radiographic imaging apparatus changes the predetermined value according to a frame rate of the dynamic imaging.

9. The radiographic imaging system according to claim 1, wherein the hardware processor of the radiographic imaging apparatus generates, based on the corrected time, a timing pulse signal serving as a reference for imaging.

10. The radiographic imaging system according to claim 1, wherein the hardware processor of the radiographic imaging apparatus repeatedly performs the time synchronization communication while the radiographic imaging apparatus is connected with the radiation emission control apparatus via the communicator.

11. The radiographic imaging system according to claim 1, wherein in a case where the communicator is a pulse-dedicated line, the hardware processor of the radiographic imaging apparatus generates a timing pulse signal serving as a reference for imaging without performing the time synchronization communication.

12. A radiographic imaging apparatus to be connected with a radiation emission control apparatus via a communicator, the radiographic imaging apparatus comprising:
a time measurer that measures a time; and
a hardware processor that performs a time synchronization communication with the radiation emission control apparatus via the communicator to adjust the time of the time measurer to a time measured by the radiation emission control apparatus, and
wherein the hardware processor corrects the time of the time measurer in response to determining that a time difference between the radiation emission control apparatus and the radiographic imaging apparatus in the time synchronization communication is equal to or smaller than a predetermined value.

13. A radiographic imaging method that is performed by a radiographic imaging apparatus to be connected with a radiation emission control apparatus via a communicator, the radiographic imaging method comprising:
performing a time synchronization communication with the radiation emission control apparatus via the communicator to adjust a time of the radiographic imaging apparatus to a time measured by the radiation emission control apparatus,
wherein the performing includes correcting the time of the radiographic imaging apparatus in response to determining that a time difference between the radiation emission control apparatus and the radiographic imaging apparatus in the time synchronization communication is equal to or smaller than a predetermined value.

14. A non-transitory computer-readable storage medium storing a program causing a radiographic imaging apparatus as a computer to be connected with a radiation emission control apparatus via a communicator to:
measure a time; and
perform a time synchronization communication with the radiation emission control apparatus via the communicator to adjust the measured time to a time measured by the radiation emission control apparatus,
wherein the program causes the computer to correct the measured time in response to determining that a time difference between the radiation emission control apparatus and the radiographic imaging apparatus in the time synchronization communication is equal to or smaller than a predetermined value.
